(19) United States
(12) Patent Application Publication
(10) Pub. No.: US 2026/0296190 A1
(43) Pub. Date: Oct. 1, 2026

(54) SYSTEMS AND METHODS FOR STREAMING DRIVING SCENES INTO A VEHICLE CABIN

(71) Applicant: TOYOTA MOTOR ENGINEERING & MANUFACTURING NORTH AMERICA,INC., PLANO, TX (US)

(72) Inventors: YUTA TSUBAKI, Mountain View, CA (US); SEYHAN UCAR, Mountain View, CA (US); EMRAH AKIN SISBOT, Mountain View, CA (US); XIAOFEI CAO, Mountain View, CA (US); YONGKANG LIU, Mountain View, CA (US); KENTARO OGUCHI, Mountain View |, CA (US)

(73) Assignees: TOYOTA MOTOR ENGINEERING & MANUFACTURING NORTH AMERICA,INC., PLANO, TX (US); TOYOTA JIDOSHA KABUSHIKI KAISHA, TOYOTA-SHI (JP)

(21) Appl. No.: 19/089,775

(22) Filed: Mar. 25, 2025

(51) Int. Cl. B60K 35/28

(52) U.S. Cl. CPC B60K 35/28; B60K 2360/176; B60K 2360/1868; B60K 2360/592

(57) ABSTRACT

Systems and methods are provided for streaming driving scenes. The systems and methods may retrieve a driving scene from a database of sensor data of a plurality of vehicles. The driving scene may include a plurality of images corresponding to a selected view. The systems and methods may determine a trajectory of an ego vehicle. The trajectory of the ego vehicle may be based on at least one of an acceleration, suspension, speed, breaking, maneuvering, direction, driving pattern, road condition, and environmental condition encountered by the ego vehicle during travel. The systems and methods may synchronize the driving scene according to the trajectory. Synchronizing the driving scene according to the trajectory may include arranging the plurality of images to align with a movement of travel of the ego vehicle. The systems and methods may output the synchronized driving scene to a surface of a cabin of the ego vehicle.

### TECHNICAL FIELD

The present disclosure relates generally to transforming and displaying scenes captured using sensor data obtained during operation of a vehicle, and in particular, some implementations may relate to computing architectures to transform and display the captured scenes using sensor data.

### DESCRIPTION OF RELATED ART

Passengers of a vehicle may engage in various in-cabin activities while inside the vehicle. In-cabin activities may vary based on duration of journey of the vehicle, number of passengers in the vehicle, and available resources offered within the vehicle. In-cabin activities may include listening to music and podcast, playing games, watching movies and television (TV) shows, having conversations, etc. In-cabin activities may significantly contribute to the quality of experience in traveling by making journeys fulfilling and enjoyable. With the increase in automated vehicles, additional in-cabin activities may be offered to provide a richer array of engaging experiences to passengers.

During operation, sensors within or otherwise associated with vehicles capture and record large amounts of data. The data may include sensor data of scenes captured by vehicles while driving. The recorded sensor data may be useful for certain purposes, such as improving vehicle safety by providing data for driver assistance systems. Recorded sensor data may also be useful in providing entertainment to passengers of a vehicle through in-cabin activities. Currently, vehicular systems do not offer the ability to utilize recorded sensor data to provide in-cabin entertainment and activities to passengers of a vehicle.

### BRIEF SUMMARY OF THE DISCLOSURE

According to various aspects of the disclosed technology, systems and methods for streaming driving scenes are provided.

In accordance with some implementations, a method for refining predictive driving actions is provided. The method may include: retrieving the driving scene from a database of sensor data of a plurality of vehicles; determining, based on sensor data of a vehicle, a trajectory of the vehicle; synchronizing the driving scene according to the trajectory of the vehicle; and outputting the synchronized driving scene to a surface of a cabin of the vehicle.

In some applications, the sensor data of the vehicle may be obtained from a sensor of the vehicle, wherein the sensor may include at least one of a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

In some applications, the sensor data of the vehicle may include information of an environmental condition, road condition, map, location, lane marker type, traffic, speed, direction, and object encountered by the vehicle.

In some applications, the object may include at least one of a pothole, crack, tire marking, faded road marking, debris, occlusion, road reflection, flooding, ice, fire, oil leak, uneven pavement, speed bump, erosion, raveling, sign, pole, building, structure, pedestrian, animal, and vehicle.

In some applications, the driving scene may include a plurality of images from the database of sensor data corresponding to a selected view.

In some applications, synchronizing the driving scene according to the trajectory of the vehicle may include arranging the plurality of images to align with a movement of travel of the vehicle.

In some applications, the trajectory of the vehicle may be based on at least one of an acceleration, suspension, speed, breaking, maneuvering, direction, driving pattern, road condition, and environmental condition.

In another aspect, a system for refining predictive driving actions is provided that may include one or more processors; and memory coupled to the one or more processors to store instructions, which when executed by the one or more processors, may cause the one or more processors to perform operations. The operations may include: retrieving the driving scene from a database of sensor data of a plurality of vehicles; determining, based on sensor data of a vehicle, a trajectory of the vehicle; synchronizing the driving scene according to the trajectory of the vehicle; and outputting the synchronized driving scene to a surface of a cabin of the vehicle.

In some applications, the sensor data of the vehicle may be obtained from a sensor of the vehicle, wherein the sensor may include at least one of a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

In some applications, the sensor data of the vehicle may include information of an environmental condition, road condition, map, location, lane marker type, traffic, speed, direction, and object encountered by the vehicle.

In some applications, the object may include at least one of a pothole, crack, tire marking, faded road marking, debris, occlusion, road reflection, flooding, ice, fire, oil leak, uneven pavement, speed bump, erosion, raveling, sign, pole, building, structure, pedestrian, animal, and vehicle.

In some applications, the driving scene may include a plurality of images from the database of sensor data corresponding to a selected view.

In some applications, synchronizing the driving scene according to the trajectory of the vehicle may include arranging the plurality of images to align with a movement of travel of the vehicle.

In some applications, the trajectory of the vehicle may be based on at least one of an acceleration, suspension, speed, breaking, maneuvering, direction, driving pattern, road condition, and environmental condition.

In another aspect, a non-transitory machine-readable medium is provided. The non-transitory computer-readable medium may include instructions that when executed by a processor may cause the processor to perform operations including: retrieving the driving scene from a database of sensor data of a plurality of vehicles; determining, based on sensor data of a vehicle, a trajectory of the vehicle; synchronizing the driving scene according to the trajectory of the vehicle; and outputting the synchronized driving scene to a surface of a cabin of the vehicle.

In some applications, the sensor data of the vehicle may be obtained from a sensor of the vehicle, wherein the sensor may include at least one of a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

In some applications, the sensor data of the vehicle may include information of an environmental condition, road condition, map, location, lane marker type, traffic, speed, direction, and object encountered by the vehicle.

In some applications, the object may include at least one of a pothole, crack, tire marking, faded road marking, debris, occlusion, road reflection, flooding, ice, fire, oil leak, uneven pavement, speed bump, erosion, raveling, sign, pole, building, structure, pedestrian, animal, and vehicle.

In some applications, the driving scene may include a plurality of images from the database of sensor data corresponding to a selected view.

In some applications, synchronizing the driving scene according to the trajectory of the vehicle may include arranging the plurality of images to align with a movement of travel of the vehicle.

In some applications, the trajectory of the vehicle may be based on at least one of an acceleration, suspension, speed, breaking, maneuvering, direction, driving pattern, road condition, and environmental condition.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example computing system for refining predictive driving actions, according to example applications described in the present disclosure.

FIG. 2 illustrates an example vehicle with which applications of the disclosed technology may be implemented.

FIG. 3 illustrates an example system for refining predictive driving actions, according to example applications described in the present disclosure.

FIG. 4 illustrates an example process for streaming driving scenes, according to example applications described in the present disclosure.

FIG. 5 illustrates an example image of streaming driving scenes with which applications of the disclosed technology may be implemented according to example applications described in the present disclosure.

FIG. 6 illustrates an example system for refining predictive driving actions, according to an example application described in the present disclosure.

FIG. 7 illustrates an example computing component that includes one or more hardware processors and machine-readable storage media storing a set of machine-readable/machine-executable instructions that, when executed, cause the one or more hardware processors to perform an illustrative method for refining predictive driving actions, according to example applications described in the present disclosure.

The figures are not exhaustive and do not limit the present disclosure to the precise form disclosed.

### DETAILED DESCRIPTION

The systems and methods disclosed herein may be implemented with any of a number of different ego vehicles and ego vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented as an ego vehicle. The systems and methods for retrieving, synchronizing, and outputting driving scenes can be implemented in other types of ego vehicles including gasoline-or diesel-powered vehicles, fuel-cell vehicles, electric vehicles, or other vehicles.

An ego vehicle may be traveling on a road. The ego vehicle may include one or more sensors that may be used to collect sensor data of information associated with the ego vehicle. The sensor data may include information including, but not limited to, an environmental condition, road condition, map, location, lane marker type, traffic, speed, direction, and object that the ego vehicle is encountering and performing. The sensor data of the ego vehicle may be used to determine the driving behavior of the ego vehicle.

The sensor data of a plurality of vehicles, including the ego vehicle, may be collected and stored in a database. The database may be a repository of all sensor data collected by vehicles from one or more networks.

Driving data of the ego vehicle may be determined from sensor data collected by one or more sensors of the ego vehicle, one or more sensors of one or more other vehicles, and one or more sensors of the road, such as, for example, road cameras, road sensors, etc. The driving data of the ego vehicle that is collected may include information of the driving behavior of the ego vehicle. The information of the driving behavior of the ego vehicle may include information on one or more driving actions performed by the ego vehicle, including, for example, the speed, movements (or lack of movements), location, direction of travel, and driving pattern of the ego vehicle. The driving data of the ego vehicle may include an identity of a driver of the ego vehicle. The information of the driving behavior may be associated with the identity of the driver.

The database of sensor data may include a plurality of images and/or videos (“images”) collected from a plurality of vehicles by one or more sensors. The images may be of a plurality of different locations that the plurality of vehicles have traveled through. An image may be categorized in the database based on the location it was captured in, such as, for example, Los Angeles of California, London of England, Moscow of Russia, etc., the type of image it is presenting, such as, for example, forest, desert, city, mountains, valley, vineyard, ocean side, ranch, etc., and one or more features displayed in the image, including, for example, sunrise, sunset, daylight, moonlight, sunny, raining, snowing, thunder storm, animals, people, buildings, etc.

A driving scene may be retrieved for the ego vehicle. A passenger of the ego vehicle may select a driving scene that the passenger requests to be displayed in a cabin of the ego vehicle. The passenger may select a driving scene according to one or more options, including a location, type, and feature of the image. Based on the selected driving scene, one or more images of the driving scene may be retrieved from the database of sensor data.

The driving data of the ego vehicle may be used to infer characteristics of driving behavior. Characteristics of the driving behavior of the ego vehicle may include one or more types of actions performed by the ego vehicle, a degree of repetition of each type of action, a motion pattern of the driving behavior, a period of the motion pattern of the driving behavior, and a degree of influence caused by the driving behavior of the ego vehicle to other vehicles. Types of actions that may be performed by the ego vehicle may include accelerating, decelerating, braking, changing lanes, turning, and being stationary.

The driving data may be used along with other sensor data of the ego vehicle, including information on environmental conditions, road conditions, and traffic, to determine a trajectory of the ego vehicle. The trajectory of the ego vehicle may be the path of travel that the ego vehicle is traversing. The trajectory of the ego vehicle may be predicted based on pre-existing information and updated according to changes in environmental conditions, traffic, road conditions, and other external factors that the ego vehicle encounters while the ego vehicle is traveling.

A predictive model, such as a ML model, may be used to analyze the sensor data and driving data of the ego vehicle to predict next driving actions of a vehicle. A predictive model may include a plurality of different prediction models, where each predictive model may represent a different category driving behaviors and external conditions that an ego vehicle may encounter. The predictive model may be used in determining the trajectory of the ego vehicle.

Upon determining the trajectory of the ego vehicle and retrieving the driving scene from the database of sensor data, the driving scene may be synchronized with the trajectory. Synchronizing the driving scene with the trajectory may include arranging images of the driving scene according to the trajectory of the ego vehicle. The synchronized driving scene may display one or more images in alignment with the driving behavior of the ego vehicle according to sensor data collected by the ego vehicle in real-time.

The synchronized driving scene may be outputted to the ego vehicle. The synchronized driving scene may be streamed to the ego vehicle and displayed on a surface of the ego vehicle. The surface of the ego vehicle may be any surface of the ego vehicle, including an internal surface of a cabin of the ego vehicle. An internal surface of a cabin of the ego vehicle may include a GUI, door panel, window, ceiling, backside of seat, etc. The synchronized driving scene may be displayed on a surface of the ego vehicle selected by the passenger of the ego.

Synchronizing driving scenes and streaming it to an ego vehicle to be displayed on an internal service of the ego vehicle may provide passengers of the ego vehicle with a new in-cabin activity to captivate and keep passengers entertained during their travels.

It should be noted that the terms “accurate,” “accurately,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

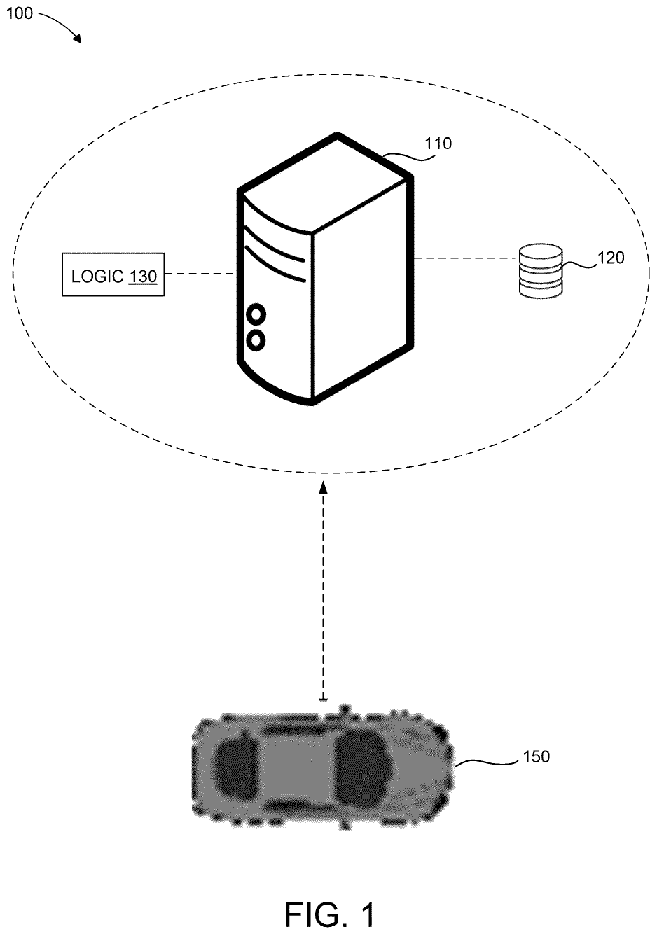

FIG. 1 illustrates an example of a computing system 100 which may be internal or otherwise associated within a vehicle 150. In some embodiments, the computing system 100 may be a machine learning (ML) pipeline and model, and use ML algorithms. In some examples, vehicle 150 may include an autonomous, semi-autonomous or manual vehicle, with which applications of the disclosed technology may be implemented. In some examples, vehicle 150 may include an automobile, truck, motorcycle, bicycle, scooter, moped, recreational vehicle and other like on-or off-road vehicles, that may include an autonomous, semi-autonomous and manual operation. In some examples, the vehicle 150 may include a computing device, such as a desktop computer, a laptop, a mobile phone, a tablet device, an Internet of Things (IoT) device, etc. The vehicle 150 may input data into computing component 110. The computing component 110 may perform one or more available operations on the input data to generate outputs, such as synchronizing and outputting driving scenes. The vehicle 150 may further display the outputs on a surface of the vehicle, such as a Graphical User Interface (GUI). The GUI may be on the vehicle 150 and may display the outputs as a two-dimensional (2D) and three-dimensional (3D) layout and map showing the various outputs generated by algorithms, such as ML algorithms, based on various input data, such as sensor data of road conditions, environmental conditions, lane markers, traffic, speed of vehicles, direction of vehicles, obstructions, and objects from vehicles and roads.

The computing system 110 in the illustrated example may include one or more processors and logic 130 that implements instructions to carry out the functions of the computing component 110, for example, retrieving a driving scene from a database of sensor data of a plurality of vehicles; determining, based on sensor data of vehicle 150, a trajectory of the vehicle 150; synchronizing the driving scene according to the trajectory of the vehicle 150; and outputting the synchronized driving scene to a surface of a cabin of the vehicle 150. The computing component 110 may store, in a database 120, details regarding sensor data and driving scenes in which some algorithms, image datasets, and assessments are performed and used to stream driving scenes. Some of the scenarios or conditions will be illustrated in the subsequent figures.

A processor may include one or more GPUs, CPUs, microprocessors or any other suitable processing system. Each of the one or more processors may include one or more single core or multicore processors. The one or more processors may execute instructions stored in a non-transitory computer readable medium. Logic 130 may contain instructions (e.g., program logic) executable by the one or more processors to execute various functions of computing component 110. Logic 130 may contain additional instructions as well, including instructions to transmit data to, receive data from, and interact with vehicle 150.

ML can refer to methods that, through the use of algorithms, are able to automatically extract intelligence or rules from training data sets and capture the same in informative models. In turn, those models are capable of making predictions based on patterns or inferences gleaned from subsequent data input into a trained model, such as, for example, predictive models for driving behaviors detection and predictive analysis. According to implementations of the disclosed technology, the ML algorithm comprises, among other aspects, algorithms implementing a Gaussian process and the like. The ML algorithms disclosed herein may be supervised and/or unsupervised depending on the implementation. The ML algorithms may emulate the observed characteristics and components of roads, vehicles and drivers to better obtain sensor data of vehicles, evaluate driving behaviors of vehicles and drivers, determine trajectories of vehicles, synchronize driving scenes with trajectories of vehicles, and output driving scenes to vehicles to accurately display driving scenes in alignment with the trajectory of the respective vehicle.

Although one example computing system 110 is illustrated in FIG. 1, in various embodiments multiple computing systems 110 can be included. Additionally, one or more systems and subsystems of computing system 100 can include its own dedicated or shared computing component 110, or a variant thereof. Accordingly, although computing system 100 is illustrated as a discrete computing system, this is for ease of illustration only, and computing system 100 can be distributed among various systems or components.

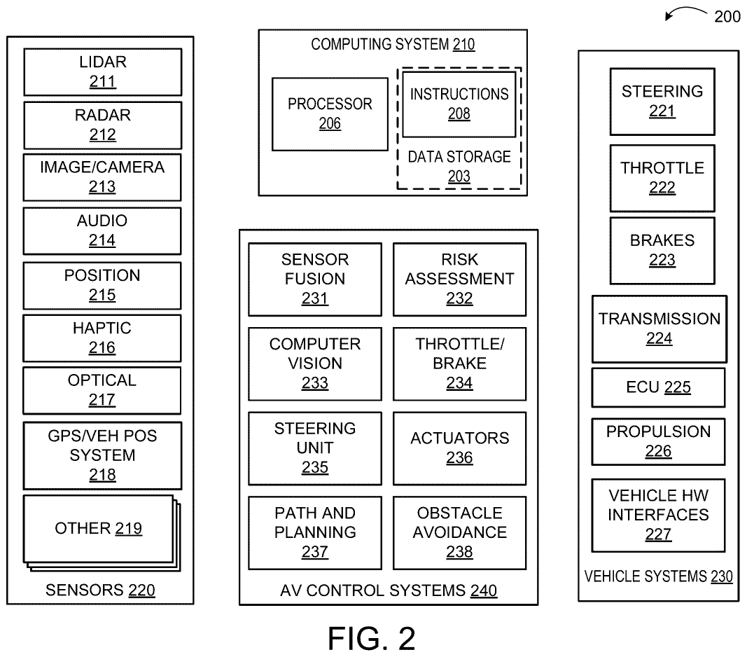

FIG. 2 illustrates an example connected vehicle 200, such as an autonomous, semi-autonomous or manual vehicle, with which applications of the disclosed technology may be implemented. As described herein, vehicle 200 can refer to a vehicle, such as an automobile, truck, motorcycle, bicycle, scooter, moped, recreational vehicle and other like on-or off-road vehicles, that may include an autonomous, semi-autonomous and manual operation. The vehicle 200 may include components, such as a computing system 210, sensors 220, vehicle systems 230, and AV control systems 240. Either of the computing system 210, sensors 220, vehicle systems 230, and AV control systems 240 can be part of an automated vehicle system/advanced driver assistance system (ADAS). ADAS can provide navigation control signals (e.g., control signals to actuate the vehicle and operate one or more vehicle systems 240 as shown in FIG. 2) for the vehicle to navigate a variety of situations. As used herein, ADAS can be an autonomous vehicle control system adapted for any level of vehicle control and driving autonomy. For example, the ADAS can be adapted for level 1, level 2, level 3, level 4, and level 5 autonomy (according to SAE standard). ADAS can allow for control mode blending (i.e., blending of autonomous and assisted control modes with human driver control). ADAS can correspond to a real-time machine perception system for vehicle actuation in a multi-vehicle environment. Vehicle 200 may include a greater or fewer quantity of systems and subsystems, and each could include multiple elements. Accordingly, one or more of the functions of the technology disclosed herein may be divided into additional functional or physical components, or combined into fewer functional or physical components. Additionally, although the systems and subsystems illustrated in FIG. 2 are shown as being partitioned in a particular way, the functions of vehicle 200 can be partitioned in other ways. For example, various vehicle systems and subsystems can be combined in different ways to share functionality.

Sensors 220 may include a plurality of different sensors to gather data regarding vehicle 200, its operator, its operation and its surrounding environment. Although various sensors are shown, it can be understood that systems and methods for synchronizing and outputting driving scenes may not require many sensors. It can also be understood that system and methods described herein can be augmented by sensors off the vehicle 200. In this example, sensors 220 include light detection and ranging (LiDAR) sensor 211, radar sensor 212, image sensors 213 (i.e., a camera), audio sensors 214, position sensor 215, haptic sensor 216, optical sensor 217, a Global Positioning System (GPS) or other vehicle positioning system 218, and other like distance measurement and environment sensing sensors 219. One or more of the sensors 220 may gather data, such as road conditions data, and send that data to the vehicle ECU or other processing unit. Sensors 220 (and other vehicle components) may be duplicated for redundancy.

Distance measuring sensors such as LiDAR sensor 211, radar sensor 212, IR sensors and other like sensors can be used to gather data to measure distances and closing rates to various external objects such as other vehicles, roads, traffic signs, pedestrians, light poles and other objects. Image sensors 213 can include one or more cameras or other image sensors to capture images and/or videos (“images”) of the environment around the vehicle, such as road surfaces, as well as internal to the vehicle. Information from image sensors 213 (e.g., camera) can be used to determine information about the environment surrounding the vehicle 200 including, for example, information regarding road surfaces and other objects surrounding vehicle 200. For example, image sensors 213 may be able to recognize specific vehicles (e.g. color, vehicle type), landmarks or other features (including, e.g., street signs, traffic lights, etc.), slope of the road, lines on the road, damages and other potentially hazardous conditions to the road, curbs, objects to be avoided (e.g., other vehicles, pedestrians, bicyclists, etc.) and other landmarks or features. Information from image sensors 213 can be used in conjunction with other information such as map data, or information from positioning system 218 to determine, refine, or verify vehicle (ego vehicle or another vehicle) location as well as detect obstructions and vehicle driving behaviors and trajectory of vehicle movement.

Vehicle positioning system 218 (e.g., GPS or other positioning system) can be used to gather position information about a current location of the vehicle as well as other positioning or navigation information, such as the positioning information about a current location and direction of movement of the vehicle according to a particular road condition.

Other sensors 219 may be provided as well. Other sensors 219 can include vehicle acceleration sensors, vehicle speed sensors, wheelspin sensors (e.g., one for each wheel), a tire pressure monitoring sensor (e.g., one for each tire), vehicle clearance sensors, left-right and front-rear slip ratio sensors, and environmental sensors (e.g. to detect weather, traction conditions, or other environmental conditions). Other sensors 219 can be further included for a given implementation of ADAS. Various sensors 220, such as other sensors 219, may be used to provide input to computing system 210 and other systems of vehicle 200 so that the systems have information useful to detect and verify vehicles and their driving behaviors.

AV control systems 240 may include a plurality of different systems/subsystems to control operation of vehicle 200. In this example, AV control systems 240 can include, autonomous driving module (not shown), sensor fusion module 231, risk assessment module 232, computer vision module 233, throttle and brake control unit 234, steering unit 235, actuator(s) 236, path and planning module 237, and obstacle avoidance module 238. Sensor fusion module 231 can be included to evaluate data from a plurality of sensors, including sensors 220. Sensor fusion module 231 may use computing system 210 or its own computing system to execute algorithms to assess inputs from the various sensors.

Computer vision module 233 may be included to process image data (e.g., image data captured from image sensors 213, or other image data) to evaluate the environment within or surrounding the vehicle. For example, algorithms operating as part of computer vision module 233 can evaluate still or moving images to determine features and landmarks (e.g., road pavements, lines of the road, damages and other potentially hazardous conditions on the road, road signs, traffic lights, lane markings and other road boundaries, etc.), obstacles (e.g., pedestrians, bicyclists, other vehicles, other obstructions in the path of the subject vehicle) and other objects. The system can include video tracking and other algorithms to recognize objects such as the foregoing, estimate their speed, map the surroundings, and so on. Computer vision module 233 may be able to model the road traffic vehicle network, predict incoming hazards and obstacles, predict road hazard, and determine one or more contributing factors to identifying obstructions. Computer vision module 233 may be able to perform depth estimation, image/video segmentation, camera localization, and object classification according to various classification techniques (including by applied neural networks).

Throttle and brake control unit 234 can be used to control actuation of throttle and braking mechanisms of the vehicle to accelerate, slow down, stop or otherwise adjust the speed of the vehicle. For example, the throttle unit can control the operating speed of the engine or motor used to provide motive power for the vehicle. Likewise, the brake unit can be used to actuate brakes (e.g., disk, drum, etc.) or engage regenerative braking (e.g., such as in a hybrid or electric vehicle) to slow or stop the vehicle.

Steering unit 235 may include any of a number of different mechanisms to control or alter the heading of the vehicle. For example, steering unit 235 may include the appropriate control mechanisms to adjust the orientation of the front or rear wheels of the vehicle to accomplish changes in direction of the vehicle during operation. Electronic, hydraulic, mechanical or other steering mechanisms may be controlled by steering unit 235.

Path and planning module 237 may be included to compute a desired path for vehicle 200 based on input from various other sensors and systems. For example, path and planning module 237 can use information from positioning system 218, sensor fusion module 231, computer vision module 233, obstacle avoidance module 238 (described below) and other systems (e.g., AV control systems 240, sensors 220, and vehicle systems 230) to determine a safe path to navigate the vehicle along a segment of a desired route. Path and planning module 237 may also be configured to dynamically update the vehicle path as real-time information is received from sensors 220 and other control systems 240.

Obstacle avoidance module 238 can be included to determine control inputs necessary to avoid obstacles, obstructions, and other vehicles detected by sensors 220 or AV control systems 240. Obstacle avoidance module 238 can work in conjunction with path and planning module 237 to determine an appropriate path to avoid and navigate around obstacles and obstructions.

Path and planning module 237 (either alone or in conjunction with one or more other module of AV Control system 240, such as obstacle avoidance module 238, computer vision module 233, and sensor fusion module 231) may also be configured to perform and coordinate one or more vehicle maneuvers. Example vehicle maneuvers can include at least one of a path tracking, stabilization and collision avoidance maneuver. With connected vehicles, such as vehicles selected to verify obstructions, vehicle maneuvers can be performed at least partially cooperatively between the connected vehicles to gather a sufficient amount of data of the obstruction. A sufficient amount of data of an obstruction may include collecting data of the obstruction at various angles and perspectives. Each different type of obstruction may warrant a different amount of data to be collected and analyzed to make the needed determinations to verify the obstruction. For example, data needed to verify a small obstruction, like a small pothole, may be minimal as the connected vehicles collecting verification data of the small pothole obstruction may only need to collect data of missing asphalt on the road. The data needed to verify a larger obstruction, like a downed traffic light, may be much more extensive as the connected vehicles collecting verification data of the downed traffic light obstruction may need to collect data of the portion of the roadway blocked by the downed traffic light, electrical issues present on the roadway, disrupted traffic flow caused by the downed traffic light, including, for example, any other vehicles or objects blocking traffic due to the downed traffic light, additional obstructions on the road caused by the downed traffic light, including, for example, cracks, potholes, debris, etc., and so on. Hence, those of ordinary skill in the art will understand what sufficient means in the context of collecting a sufficient amount of data to verify an obstruction.

Vehicle systems 230 may include a plurality of different systems/subsystems to control operation of vehicle 200. In this example, vehicle systems 230 include steering system 221, throttle system 222, brakes 223, transmission 224, electronic control unit (ECU) 225, propulsion system 226 and vehicle hardware interfaces 227. The vehicle systems 230 may be controlled by AV control systems 240 in autonomous, semi-autonomous or manual mode of vehicle 200. For example, in autonomous or semi-autonomous mode, AV control systems 240, alone or in conjunction with other systems, can control vehicle systems 230 to operate the vehicle in a fully or semi-autonomous fashion. When control is assumed, computing system 210 and AV control system 240 can provide vehicle control systems to vehicle hardware interfaces for controlled systems such as steering angle 221, throttle 222, brakes 223, or other hardware interfaces 227, such as traction force, turn signals, horn, lights, etc. This may also include an assist mode in which the vehicle takes over partial control or activates ADAS controls (e.g., AC control systems 240) to assist the driver with vehicle operation.

Computing system 210 in the illustrated example includes a processor 206, and memory 203. Some or all of the functions of vehicle 200 may be controlled by computing system 210. Processor 206 can include one or more GPUs, CPUs, microprocessors or any other suitable processing system. Processor 206 may include one or more single core or multicore processors. Processor 206 executes instructions 208 stored in a non-transitory computer readable medium, such as memory 203.

Memory 203 may contain instructions (e.g., program logic) executable by processor 206 to execute various functions of vehicle 200, including those of vehicle systems and subsystems. Memory 203 may contain additional instructions as well, including instructions to transmit data to, receive data from, interact with, and control one or more of the sensors 220, AV control systems 240 and vehicle systems 230. In addition to the instructions, memory 203 may store data and other information used by the vehicle and its systems and subsystems for operation, including operation of vehicle 200 in the autonomous, semi-autonomous or manual modes. For example, memory 203 can include data that has been communicated to the ego vehicle (e.g. via V2V communication), mapping data, a model of the current or predicted road traffic vehicle network, vehicle dynamics data, computer vision recognition data, and other data which can be useful for the execution of one or more vehicle maneuvers, for example by one or more modules of the AV control systems 240.

Although one computing system 210 is illustrated in FIG. 2, in various applications multiple computing systems 210 can be included. Additionally, one or more systems and subsystems of vehicle 200 can include its own dedicated or shared computing system 210, or a variant thereof. Accordingly, although computing system 210 is illustrated as a discrete computing system, this is for ease of illustration only, and computing system 210 can be distributed among various vehicle systems or components.

Vehicle 200 may also include a (wireless or wired) communication system (not illustrated) to communicate with other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow vehicle 200 to receive information from other objects including, for example, map data, data regarding infrastructure elements, data regarding operation and intention of surrounding vehicles, and so on. A wireless communication system may allow vehicle 200 to receive updates to data that can be used to execute one or more vehicle control modes, and vehicle control algorithms as discussed herein. Wireless communication system may also allow vehicle 200 to transmit information to other objects and receive information from other objects (such as other vehicles, user devices, or infrastructure). In some applications, one or more communication protocol or dictionaries can be used, such as the SAE J2935 V2X Communications Message Set Dictionary. In some applications, the communication system may be useful in retrieving and sending one or more data useful in detecting unsafe driving behaviors and refining predictive driving actions, as disclosed herein.

Communication system can be configured to receive data and other information from sensors 220 that is used in determining whether and to what extent control mode blending should be activated. Additionally, communication system can be used to send an activation signal or other activation information to various vehicle systems 230 and AV control systems 240 as part of controlling the vehicle. For example, communication system can be used to send signals to one or more of the vehicle actuators 236 to control parameters, for example, maximum steering angle, throttle response, vehicle braking, torque vectoring, and so on.

In some applications, computing functions for various applications disclosed herein may be performed entirely on computing system 210, distributed among two or more computing systems 210 of vehicle 200, performed on a cloud-based platform, performed on an edge-based platform, or performed on a combination of the foregoing.

Path and planning module 237 can allow for executing one or more vehicle control mode(s), and vehicle control algorithms in accordance with various implementations of the systems and methods disclosed herein. In operation, path and planning module 237 (e.g., by a driver intent estimation module, not shown) can receive information regarding human control input used to operate the vehicle. As described above, information from sensors 220, actuators 236 and other systems can be used to determine the type and level of human control input. Path and planning module 237 can use this information to predict driver action. Path and planning module 237 can use this information to generate a predicted path and model the road traffic vehicle network. This may be useful in evaluating road conditions, and determining and verifying obstructions. As also described above, information from sensors, and other systems can be used to evaluate road conditions, and determine and verify obstructions. Eye state tracking, attention tracking, or intoxication level tracking, for example, can be used to determine vehicle movement patterns according to inherent human behavior. It can be understood that the driver state can contribute to verifying obstructions as disclosed herein. Driver state can be provided to a risk assessment module 232 to determine the level of risk associated with a vehicle operation, and detecting unsafe driving behaviors and refining predictive driving actions. Although not illustrated in FIG. 2, where the assessed risk contributes to determining vehicle movement patterns according to inherent human behaviors, a verification strategy may be generated and provided to vehicle 200 to verify obstructions. Aspects of synchronizing and outputting driving scenes will be disclosed with reference to subsequent figures.

Path and planning module 237 can receive state information such as, for example from visibility maps, traffic and weather information, hazard maps, and local map views. Information from a navigation system can also provide a mission plan including maps and routing to path and planning module 237.

The path and planning module 237 (e.g., by a driver intent estimation module, not shown) can receive this information and predict behavior characteristics within a future time horizon. This information can be used by path and planning module 237 for executing one or more planning decisions. Planning decisions can be based on one or more policy (such as defensive driving policy). Planning decisions can be based on one or more level of autonomy, connected vehicle actions, one or more policy (such as defensive driving policy, cooperative driving policy, such as swarm or platoon formation, leader following, etc.). Path and planning module 237 can generate an expected model for the road traffic hazards and assist in creating a predicted traffic hazard level and verification strategy for vehicles to implement.

Path and planning module 237 can receive risk information from risk assessment module 232. Path and planning module 237 can receive vehicle capability and capacity information from one or more vehicle systems 230. Vehicle capability can be assessed, for example, by receiving information from vehicle hardware interfaces 227 to determine vehicle capabilities and identify a reachable set model. Path and planning module 237 can receive surrounding environment information (e.g., from computer vision module 233, and obstacle avoidance module 238). Path and planning module 237 can apply risk information and vehicle capability and capacity information to trajectory information (e.g., based on a planned trajectory and driver intent) to determine a safe or optimized trajectory for the vehicle given the drivers intent, policies (e.g. safety or vehicle cooperation policies), communicated information, given one or more obstacles in the surrounding environment, and road conditions. This trajectory information can be provided to controller (e.g., ECU 225) to provide partial or full vehicle control in the event of a risk level above threshold. A signal from risk assessment module 232 can be used generate countermeasures described herein. A signal from risk assessment module 232 can trigger ECU 225 or another AV control system 240 to take over partial or full control of the vehicle.

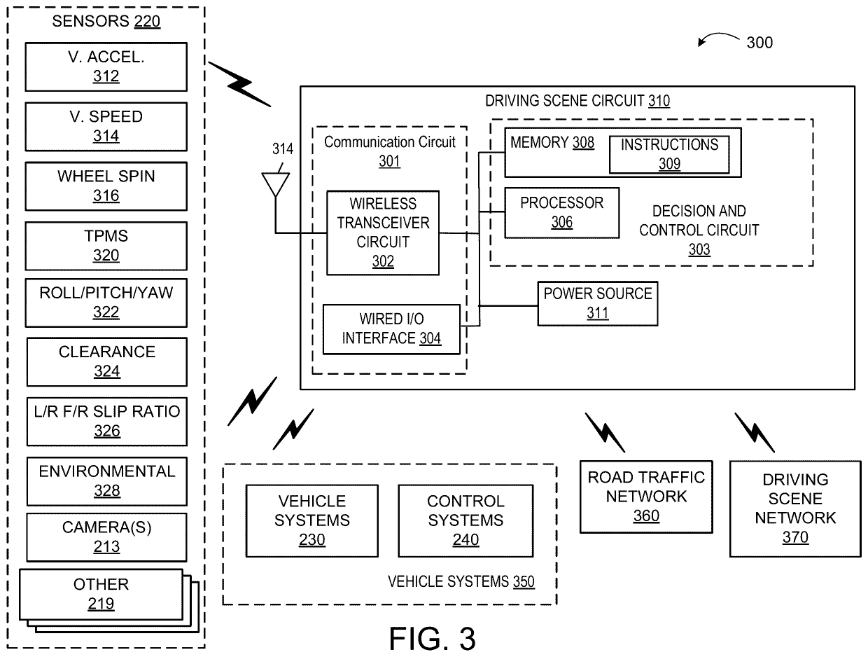

FIG. 3 illustrates an example architecture for synchronizing and outputting driving scenes described herein. Referring now to FIG. 3, in this example, a driving scene streaming system 300 includes a driving scene circuit 310, a plurality of sensors 220, and a plurality of vehicle systems 350. Also included are various elements of road traffic network 360 and driving scene network 370 with which the driving scene streaming system 300 can communicate. It can be understood that a road traffic network 360 can include various elements that are navigating and important in navigating a road traffic network, such as vehicles, pedestrians (with or without connected devices that can include aspects of predictive driving behavior system 300 disclosed herein), or infrastructure (e.g., traffic signals, sensors, such as traffic cameras, databases, central servers, weather sensors, etc.). It can also be understood that a road traffic network 360 can include various elements that are navigating and important in navigating a road traffic network, such as roads, infrastructure (e.g., road sensors, such as road cameras, databases, central servers, weather sensors, etc.), weather, road constructions, or accidents. It can also be understood that a driving scene network 370 may include various elements that are navigating and important in navigating a driving scene network, such as sensor data obtained by one or more vehicles, where the vehicle sensor data may include information of environmental conditions, road conditions, maps, locations, lane marker types, traffic, speed, direction, and objects encountered by one or more vehicles during operation of travel. Other elements of the road traffic network 360 and driving scene network 370 can include connected elements at workplaces, or the home (such as vehicle chargers, connected devices, appliances, etc.).

Driving scene streaming system 300 can be implemented as and include one or more components of the vehicle 200 shown in FIG. 2. Sensors 220, vehicle systems 350, elements of road traffic network 360, and elements of driving scene network 370 can communicate with the driving scene circuit 310 via a wired or wireless communication interface. As previously alluded to, elements of road traffic network 360 and driving scene network 370 can correspond to connected or unconnected devices, infrastructure (e.g., traffic signals, sensors, such as traffic cameras, weather sensors, road cameras, etc.), vehicles, pedestrians, obstacles, etc. that are in a broad or immediate vicinity of ego-vehicle (e.g., vehicle 200) or otherwise important to the navigation of the road traffic network or driving scene network (such as remote infrastructure). Although sensors 220, vehicle systems 350, road traffic network 360, and driving scene network 370 are depicted as communicating with driving scene circuit 310, they can also communicate with each other, as well as with other vehicle systems 350 and directly with an element of the road traffic network 360 and driving scene network 370. Data as disclosed herein can be communicated to and from the driving scene circuit 310. For example, various infrastructure (example element of road traffic network 360 or driving scene network 370) can include one or more databases, such as vehicle crash data or weather data. This data can be communicated to the circuit 310, and such data can be updated based on outcomes for one or more maneuvers or navigation of the road traffic network, vehicle telematics, driver state (physical and mental), vehicle data from sensors 220 (e.g., tire pressure or brake status) from the vehicle. Similarly, traffic data, vehicle state data, time of travel, demographics data for drivers can be retrieved and updated. All of this data can be included in and contribute to predictive analytics (e.g., by machine learning) of accident possibility, and determinations of road conditions and poor, hazard road conditions. Similarly, models, circuits, and predictive analytics can be updated according to various outcomes.

Driving scene circuit 310 can evaluate, retrieve, synchronize and output driving scenes to accurately display driving scenes to vehicle 200 as described herein. Driving scene circuit 310 may be configured to place a filter on a driving scene before outputting the driving scene to be streamed and displayed in vehicle 200. As will be described in more detail herein, the synchronization of driving scenes can have one or more contributing factors. Various sensors 220, vehicle systems 350, road traffic network 360 elements, and driving scene network 370 elements may contribute to gathering data for evaluating vehicle driving behaviors, predicting driving actions, and determining trajectories of vehicle 200. For example, the driving scene circuit 310 can include at least one of an vehicle driving behavior detection and response circuit. The driving scene circuit 310 can be implemented as an ECU or as part of an ECU such as, for example electronic control unit 225. In other applications, driving scene circuit 310 can be implemented independently of the ECU, for example, as another vehicle system.

Driving scene circuit 310 can be configured to evaluate vehicle driving behaviors, predict driving actions, determine trajectories of vehicle 200, retrieve driving scenes, synchronize driving scenes according to trajectories of vehicle 200, and output driving scenes to vehicle 200. Driving scene circuit 310 may include a communication circuit 301 (including either or both of a wireless transceiver circuit 302 with an associated antenna 314 and wired input/output (I/O) interface 304 in this example), a decision and control circuit 303 (including a processor 306 and memory 308 in this example) and a power source 311 (which can include power supply). It is understood that the disclosed driving scene circuit 310 can be compatible with and support one or more standard or non-standard messaging protocols.

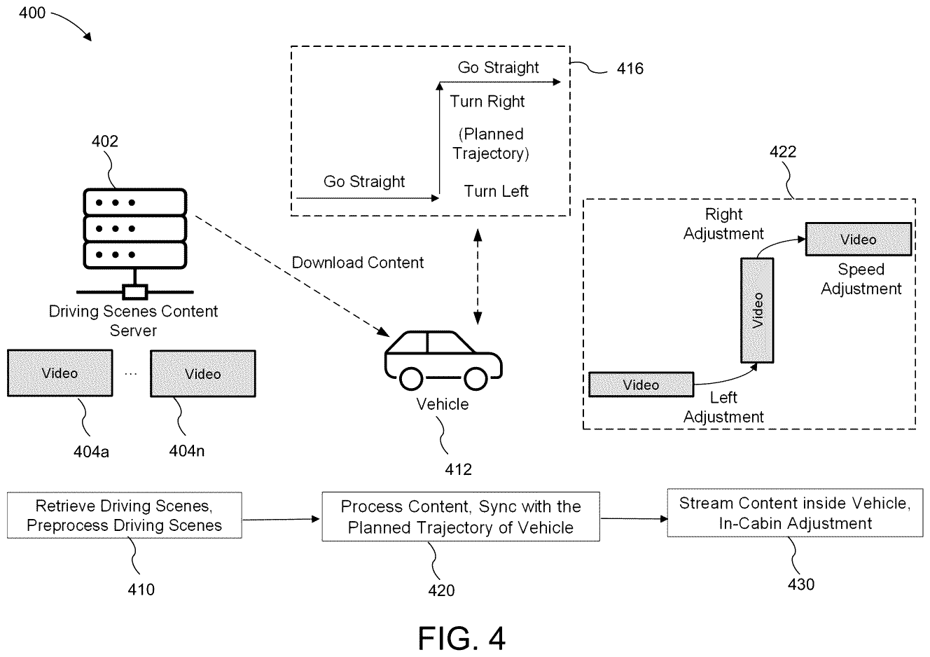

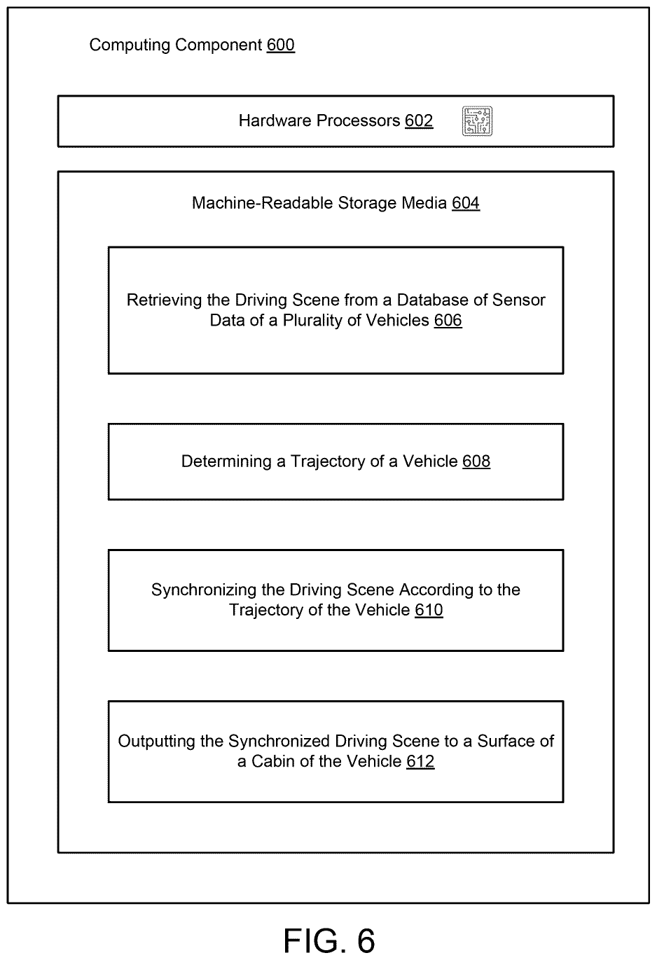

Components of driving scene circuit 310 are illustrated as communicating with each other via a data bus, although other communication in interfaces can be included. Decision and control circuit 303 can be configured to control one or more aspects of vehicle driving behavior detection and response. Decision and control circuit 303 can be configured to execute one or more steps described with reference to FIG. 4 and FIG. 6 (described below).

Processor 306 can include a GPU, CPU, microprocessor, or any other suitable processing system. The memory 308 may include one or more various forms of memory or data storage (e.g., flash, RAM, etc.) that may be used to store the calibration parameters, images (analysis or historic), point parameters, instructions and variables for processor 306 as well as any other suitable information. Memory 308 can be made up of one or more modules of one or more different types of memory, and may be configured to store data and other information as well as operational instructions 309 that may be used by the processor 306 to execute one or more functions of driving scene circuit 310. For example, data and other information can include vehicle driving data, such as a determined familiarity of the driver with driving and the vehicle. The data can also include values for signals of one or more sensors 220 useful in detecting driving actions and determining trajectories of vehicle 200. Operational instruction 309 can contain instructions for executing logical circuits, models, and methods as described herein.

Although the example of FIG. 3 is illustrated using processor and memory circuitry, as described below with reference to circuits disclosed herein, decision and control circuit 303 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a driving scene circuit 310. Components of decision and control circuit 303 can be distributed among two or more decision and control circuits 303, performed on other circuits described with respect to driving scene circuit 310, be performed on devices (such as cell phones) performed on a cloud-based platform (e.g. part of infrastructure), performed on distributed elements of the road traffic network 360, such as at multiple vehicles, user device, central servers, performed on an edge-based platform, and performed on a combination of the foregoing.

Communication circuit 301 may include either or both a wireless transceiver circuit 302 with an associated antenna 314 and a wired I/O interface 304 with an associated hardwired data port (not illustrated). As this example illustrates, communications with driving scene circuit 310 can include either or both wired and wireless communications circuits 301. Wireless transceiver circuit 302 can include a transmitter and a receiver (not shown), e.g., an vehicle driving behavior detection and verification broadcast mechanism, to allow wireless communications via any of a number of communication protocols such as, for example, WiFi (e.g. IEEE 802.11 standard), Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by driving scene circuit 310 to/from other components of the vehicle, such as sensors 220, vehicle systems 350, infrastructure (e.g., servers cloud based systems), and other devices or elements of road traffic network 360. These RF signals can include information of almost any sort that is sent or received by vehicle.

Wired I/O interface 304 can include a transmitter and a receiver (not shown) for hardwired communications with other devices. For example, wired I/O interface 304 can provide a hardwired interface to other components, including sensors 220, vehicle systems 350. Wired I/O interface 304 can communicate with other devices using Ethernet or any of a number of other wired communication protocols whether standardized, proprietary, open, point-to-point, networked or otherwise.

Power source 311 such as one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, another vehicle battery, alternator, etc.), an energy harvester (e.g., solar cells, piezoelectric system, etc.), or it can include any other suitable power supply. It is understood power source 311 can be coupled to a power source of the vehicle, such as a battery and alternator. Power source 311 can be used to power the driving scene circuit 310.

Sensors 220 can include one or more of the previously mentioned sensors 220. Sensors 220 can include one or more sensors that may or not otherwise be included on a standard vehicle (e.g., vehicle 200) with which the driving scene circuit 310 is implemented. In the illustrated example, sensors 220 include vehicle acceleration sensors 312, vehicle speed sensors 314, wheelspin sensors 316 (e.g., one for each wheel), a tire pressure monitoring system (TPMS) 320, accelerometers such as a 3-axis accelerometer 322 to detect roll, pitch and yaw of the vehicle, vehicle clearance sensors 324, left-right and front-rear slip ratio sensors 326, environmental sensors 328 (e.g., to detect weather, salinity or other environmental conditions), and camera(s) 213 (e.g. front rear, side, top, bottom facing). Additional sensors 219 can also be included as may be appropriate for a given implementation driving scene streaming system 300.

Vehicle systems 350 can include any of a number of different vehicle components or subsystems used to control or monitor various aspects of the vehicle and its performance. For example, it can include any or all of the aforementioned vehicle systems 240 and control systems 230 shown in FIG. 2. In this example, the vehicle systems 350 may include a GPS or other vehicle positioning system 218.

During operation, driving scene circuit 310 can receive information from various vehicle sensors 220, vehicle systems 350, road traffic network 360, and driving scene network 370 to retrieve, synchronize and output driving scenes to accurately display driving scenes to a vehicle, such as vehicle 200. Also, the driver, owner, and operator of the vehicle may manually trigger one or more processes described herein for retrieve, synchronize and output driving scenes. Communication circuit 301 can be used to transmit and receive information between the driving scene circuit 310, sensors 220 and vehicle systems 350. Also, sensors 220 and driving scene circuit 310 may communicate with vehicle systems 350 directly or indirectly (e.g., via communication circuit 301 or otherwise). Communication circuit 301 can be used to transmit and receive information between driving scene circuit 310, one or more other systems of a vehicle 200, but also other elements of a road traffic network 360 and driving scene network 370, such as vehicles, roads, devices (e.g., mobile phones), systems, networks (such as a communications network and central server), and infrastructure.

In various applications, communication circuit 301 can be configured to receive data and other information from sensors 220 and vehicle systems 350 that is used in retrieving, synchronizing and outputting driving scenes to a vehicle, such as vehicle 200. As one example, when data is received from an element of road traffic network 360 or driving scene network 370 (such as from a driver's user device), communication circuit 301 can be used to send an activation signal and activation information to one or more vehicle systems 350 or sensors 220 for the vehicle to implement a verification strategy to retrieve, synchronize and output driving scenes. For example, it may be useful for vehicle systems 350 or sensors 220 to provide data useful in retrieving, synchronizing and outputting driving scenes to a vehicle. Alternatively, driving scene circuit 310 can be continuously receiving information from vehicle system 350, sensors 220, other vehicles, devices and infrastructure (e.g., those that are elements of road traffic network 360 or driving scene network 370). Further, upon detecting vehicle driving behavior, communication circuit 301 can send a signal to other components of the vehicle, infrastructure, or other elements of the road traffic network or driving scene network based on the detection of the vehicle driving behavior. For example, the communication circuit 301 can send a signal to a vehicle system 350 that indicates a control input for performing one or more predictive analysis of the vehicle driving behavior to determine a trajectory of the vehicle. In some applications upon retrieving at least one driving scene according to a selected view, the driving scene may be synchronized according to the trajectory of the vehicle. In some applications, synchronized driving scenes may be outputted to a vehicle, such as vehicle 200, to be displayed on a surface of a cabin of the vehicle. In more specific examples, upon detection of vehicle driving behavior of vehicle 200 (e.g., by sensors 220, and vehicle system 350 or by elements of the road traffic network 360), one or more signals can be sent to a vehicle system 350 and driving scene circuit 310 to determine a trajectory of vehicle 200, and driving scene circuit 300 may synchronize retrieved driving scenes with the trajectory of vehicle 200 to accurately output and display the synchronized driving scene on a surface of a cabin of vehicle 200.

The examples of FIGS. 2 and 3 are provided for illustration purposes only as examples of vehicle 200 and driving scene streaming system 300 with which applications of the disclosed technology may be implemented. One of ordinary skill in the art reading this description will understand how the disclosed applications can be implemented with vehicle platforms.

FIG. 4 illustrates an example process 400 that includes one or more steps that may be performed to retrieve, synchronize and output driving scenes to accurately display driving scenes to an ego vehicle, such as vehicle 200. In some applications, the process 400 can be executed, for example by the computing component 110 of FIG. 1. In another application, the process 400 may be implemented as the computing component 110 of FIG. 1. In other applications, the process 400 may be implemented as, for example, the computing system 210 of FIG. 2 and the driving scene streaming system 300 of FIG. 3. The process 400 may include a server. The process 400 may be implemented by one or more vehicles where the one or more vehicles may form a P2P or V2V network.

At step 410, the computing component 110 retrieves driving scenes from a database and/or content server 402.

A vehicle, such as ego vehicle 412, may be traveling on a road. The ego vehicle 412 may include, for example, an automobile, truck, motorcycle, bicycle, scooter, moped, recreational vehicle and other like on-or off-road vehicles. The ego vehicle 412 may include, for example, an autonomous, semi-autonomous and manual operation. The ego vehicle 412 may include one or more sensors that may be used to collect sensor data of information associated with the ego vehicle 412. The sensor data may include information including, but not limited to, an environmental condition, road condition, map, location, lane marker type, traffic, speed, direction, and object that the ego vehicle 412 is encountering and performing. The sensor data of the ego vehicle 412 may be used to determine the driving behavior of the ego vehicle 412 and the driving behavior of each of one or more other vehicles. Each of the one or more other vehicles may include one or more sensors that may be used to collect sensor data of the driving behavior of itself and the driving behavior of each of the other vehicles, including the ego vehicle 412. Other sensors of roads, infrastructures, etc., may collect sensor data on the ego vehicle 412 and each of the other vehicles. Many variations are possible.

The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received by at least one sensor. The ego vehicle 412 may be monitored while traveling on the road to obtain sensor data of the ego vehicle 412. One or more sensors may be used to collect the sensor data of the ego vehicle 412. The sensor data of a plurality of vehicles, including the ego vehicle 412, may be collected and stored in a database and/or content server 402. The database and/or content server 402 may be a repository of all sensor data collected by vehicles from one or more networks.

The sensor data of the ego vehicle 412 collected from multiple sensors may be combined to provide a collective and complete driving data of the ego vehicle 412. Driving data of the ego vehicle 412 may be determined from sensor data collected by one or more sensors of the ego vehicle 412, one or more sensors of one or more other vehicles, and one or more sensors of the road, such as, for example, road cameras, road sensors, etc. The driving data of the ego vehicle 412 that is collected may include information of the driving behavior of the ego vehicle 412. The information of the driving behavior of the ego vehicle 412 may include information on one or more driving actions performed by the ego vehicle 412, including, for example, the speed, movements (or lack of movements), location, direction of travel, and driving pattern of the ego vehicle 412. The driving data of the ego vehicle 412 may include an identity of a driver of the ego vehicle 412. The information of the driving behavior may be associated with the identity of the driver.

The database and/or content server 402 of sensor data may include sensor data collected by a plurality of vehicles. The sensor data stored in the database and/or content server 402 may include a plurality of images and/or videos (“images”) 404a-404n collected from a plurality of vehicles by one or more sensors. The images 404a-404n may be of a plurality of different locations that the plurality of vehicles have traveled through. Such locations may include, but are not limited to, Paris of France, Rome of Italy, New York City of New York, Maui of Hawaii, Sydney of Australia, Tokyo of Japan, Egypt of Africa, etc. An image 404a-404n may be categorized in the database and/or content server 402 based on the location it was captured in. An image 404a-404n may also be categorized in the database and/or content server 402 based on the type of image it is presenting, such as, for example, forest, desert, city, mountains, valley, vineyard, ocean side, ranch, etc. An image 404a-404n may also be categorized in the database and/or content server 402 based on one or more features displayed in the image, including, for example, sunrise, sunset, daylight, moonlight, sunny, raining, snowing, thunder storm, animals, people, buildings, etc. Many variations are possible.

A driving scene may be retrieved for the ego vehicle 412. A passenger of the ego vehicle 412 may select a driving scene that the passenger requests to be displayed in a cabin of the ego vehicle 412. The passenger may select a driving scene according to one or more options, including a location, type, and feature of the image. Based on the selected driving scene, one or more images 404a-404n of the driving scene may be retrieved from the database and/or content server 402 of sensor data.

At step 420, the computing component 110 determines a trajectory of an ego vehicle 412 and synchronizes the driving scenes with the trajectory.

The driving data of the ego vehicle 412 may be used to infer characteristics of driving behavior. The driving data of one or more other vehicles may be used to infer characteristics of the driving behavior of the ego vehicle 412. Characteristics of the driving behavior of the ego vehicle 412 may include one or more types of actions performed by the ego vehicle 412, a degree of repetition of each type of action, a motion pattern of the driving behavior, a period of the motion pattern of the driving behavior, and a degree of influence caused by the driving behavior of the ego vehicle 412 to other vehicles. Types of actions that may be performed by the ego vehicle 412 may include accelerating, decelerating, braking, changing lanes, turning, and being stationary.

The driving data may be used along with other sensor data of the ego vehicle 412, including information on environmental conditions, road conditions, and traffic, to determine a trajectory of the ego vehicle 412. The trajectory of the ego vehicle 412 may be the path of travel that the ego vehicle 412 is traversing. The trajectory of the ego vehicle 412 may be determined based on the present sensor data obtained during the present operation of the ego vehicle 412. The trajectory of the ego vehicle 412 may be predicted, at least to an extent, according to a destination of the ego vehicle 412. The trajectory of the ego vehicle 412 may be updated as the ego vehicle 412 is in motion as the vehicle performs different types of actions. The trajectory of the ego vehicle 412 may be updated based on changes in environmental conditions, traffic, road conditions, and other external factors that the ego vehicle 412 encounters while the ego vehicle 412 is traveling. Many variations are possible.

A predictive model, such as a ML model, may be used to analyze the sensor data and driving data of the ego vehicle 412 to predict next driving actions of a vehicle. A predictive model may include a plurality of different prediction models, where each predictive model may represent a different category driving behaviors and external conditions that an ego vehicle 412 may encounter. The predictive model may be used in determining the trajectory of the ego vehicle 412.

Each of the predictive models may include one or more algorithms used to determine the predicted next driving data and trajectory of the ego vehicle 412 based on the environmental data, traffic data, and road condition data of the ego vehicle 412. The one or more algorithms may be pre-stored. The one or more algorithms may include a plurality of equations and methods to determine the predicted next driving data and trajectory. In other applications, each of the predictive models may include ML and/or Al logic. ML and/or Al logic may be used to determine the predicted next driving data and trajectory. The ML and/or Al logic may use data from previous sessions, whether on the same ego vehicle 412 or other vehicles, and stored data to more quickly and efficiently determine the predicted next driving data to be performed and trajectory of the ego vehicle 412, including, for example, types of actions predicted to be performed and a path of travel to be taken.

The trajectory of the ego vehicle 412 may be determined to include directions 416. Directions 416 may include the ego vehicle 412 going straight for a first distance, such as, for example, 5 miles. When the ego vehicle 412 has traveled the first distance of 5 miles, the trajectory of the ego vehicle 412 may direct the ego vehicle 412 to make a left turn and then proceed straight for second distance, such as, for example 10 miles. Upon traveling the second distance of 10 miles, the trajectory of the ego vehicle 412 may direct the ego vehicle 412 to make a right turn, followed by a direction to travel straight for a third distance. The trajectory of the ego vehicle 412 may include additional actions not displayed in directions 416.

Upon determining the trajectory of the ego vehicle 412 and retrieving the driving scene from the database and/or content server 402 of sensor data, the driving scene may be synchronized with the trajectory, i.e., synchronized driving scene 422. Synchronizing the driving scene with the trajectory may include arranging images of the driving scene according to the trajectory of the ego vehicle 412. The driving scene may be synchronized with the current trajectory of the ego vehicle 412 according to sensor data of the ego vehicle 412 presently obtained during the current operation of the ego vehicle 412. The driving scene may be updated according to updates to the trajectory of the ego vehicle 412 based on new sensor data obtained by the ego vehicle 412 during its operation. The synchronized driving scene 422 may include one or more images arranged in alignment with the driving behavior of the ego vehicle 412 according to sensor data collected by the ego vehicle 412 in real-time.

For example, the synchronized driving scene 422 may include images retrieved from the database and/or content server 402 in alignment with the directions 416 of the trajectory of the ego vehicle 412. A first set of images may be used for the ego vehicle 412 when the ego vehicle 412 is traveling straight for the first distance. The first set of images may be adjusted and transitioned to a second set of images as the ego vehicle 412 is turning left upon completing the first distance. The second set of images may be used for the ego vehicle 412 when the ego vehicle 412 is traveling straight for the second distance after completing the left turn. The second set of images may be adjusted and transitioned to a third set of images as the ego vehicle 412 is turning right upon completing the second distance. The third set of images may be used for the ego vehicle 412 when the ego vehicle 412 is traveling straight for the third distance after completing the right turn. Although not displayed in FIG. 4, the synchronized driving scene 422 may include additional images for additional actions to be performed in the trajectory of the ego vehicle 412.

At step 430, the computing component 110 outputs the synchronized driving scene to the ego vehicle 412 to display the synchronized driving scene to a surface of the ego vehicle 412.

The synchronized driving scene 422 may be outputted to the ego vehicle 412. The synchronized driving scene 422 may be streamed to the ego vehicle 412 and displayed on a surface of the ego vehicle 412. The surface of the ego vehicle 412 may be any surface of the ego vehicle 412, including an internal surface of a cabin of the ego vehicle 412. An internal surface of a cabin of the ego vehicle 412 may include a GUI, door panel, window, ceiling, backside of seat, etc. The synchronized driving scene 422 may be displayed on a surface of the ego vehicle 412 selected by the passenger of the ego. The synchronized driving scene 42 may be adjusted to fit on the selected surface of the ego vehicle 412. Many variations are possible.

The synchronized driving scene 422 may be filtered before being outputted to the ego vehicle 412. Filtering the synchronized driving scene 422 may include activating a mode of operation with the ego vehicle 412. A mode of operation may include types of driving modes, such as, for example, Adaptive Cruise Control (ACC), Lane Tracing Assist (LTA), Off-Road, 4 Wheel Drive High Range (4H), and 4 Wheel Drive Low (4L). Activating a mode of operation may limit driving actions performed by the ego vehicle 412. Limiting driving actions performed by the ego vehicle 412 may allow the synchronized driving scene 422 to be streamed more efficiently, resulting in the synchronized driving scene to be displayed more clearly and seamlessly as the trajectory of the ego vehicle 412 updates. Activating a mode of operation with the ego vehicle 412 may further assist with determining the trajectory of the ego vehicle 412 more efficiently, allowing for driving scenes to be synchronized with the trajectory more proficiently.

Synchronizing driving scenes and streaming it to an ego vehicle to be displayed on an internal service of the ego vehicle may provide passengers of the ego vehicle with a new in-cabin activity to captivate and keep passengers entertained during their travels.

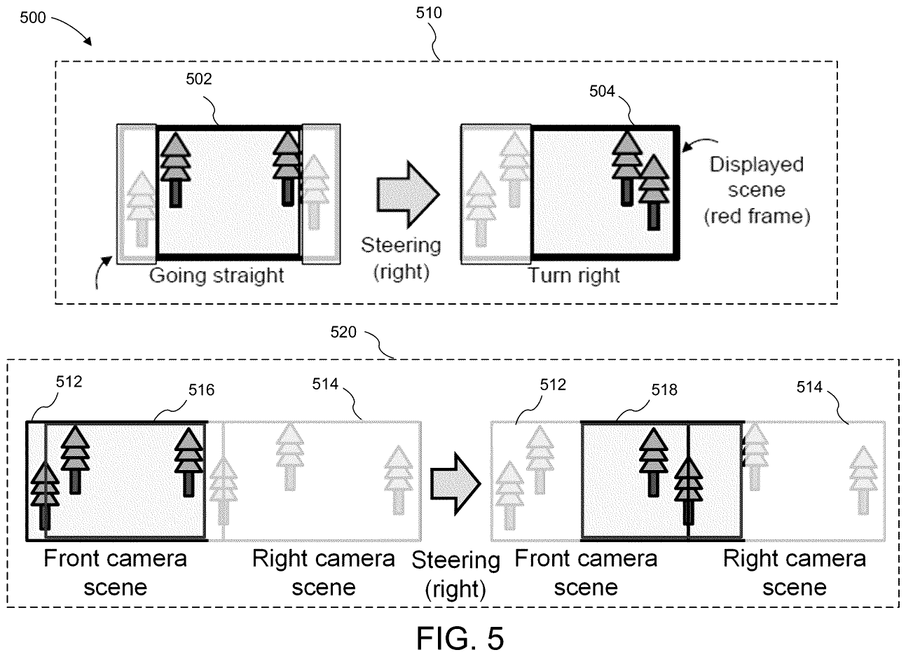

FIG. 5 illustrates an example diagram 500 that includes one or more example processes 510 and 520 of synchronized driving scenes being displayed in an ego vehicle, such as ego vehicle 200. In some applications, the processes 510 and 520 can be executed, for example by the computing component 110 of FIG. 1. In another application, the processes 510 and 520 may be implemented as the computing component 110 of FIG. 1. In other applications, the processes 510 and 520 may be implemented as, for example, the computing system 210 of FIG. 2 and the driving scene streaming system 300 of FIG. 3. The processes 510 and 520 may include a server. The processes 510 and 520 may be implemented by one or more vehicles where the one or more vehicles may form a P2P or V2V network.

In process 510, synchronized driving scene 502 may be displayed in the ego vehicle as the ego vehicle is traveling straight along a given path. As the ego vehicle is in the process of turning right, the synchronized driving scene 502 may be adjusted and transitioned to synchronized driving scene 504. In this way, the synchronized driving scene displayed to a passenger in the ego vehicle may be aligned to the driving behavior and trajectory of the ego vehicle such that the passenger obtains a perception that the features in the displayed synchronized driving scene are accurately moving and changing according to the movements of the ego vehicle.

In process 520, driving scenes 512 and 514 may have been captured using two or more cameras, such as a front camera and a right side camera, respectively. Synchronized driving scene 516 may be displayed in the ego vehicle as the ego vehicle is traveling straight along a given path. As the ego vehicle is in the process of turning right, the synchronized driving scene 516 may be adjusted and transitioned to the synchronized driving scene 518 by moving from the driving scene 512 to the driving scene 514 in proportion to the amount of movement performed by the ego vehicle. In this way, the synchronized driving scene displayed to a passenger in the ego vehicle may be aligned to the driving behavior and trajectory of the ego vehicle such that the passenger obtains a perception that the features in the displayed synchronized driving scene are accurately moving and changing according to the movements of the ego vehicle.

FIG. 6 illustrates an example computing component 600 that includes one or more hardware processors 602 and machine-readable storage media 604 storing a set of machine-readable/machine-executable instructions that, when executed, cause the hardware processor(s) 602 to perform an illustrative method of streaming driving scenes. It should be appreciated that there can be additional, fewer, or alternative steps performed in similar or alternative orders, or in parallel, within the scope of the various examples discussed herein unless otherwise stated. The computing component 600 may be implemented as the computing component 110 of FIG. 1, the computing system 210 of FIG. 2, the driving scene streaming system 300 of FIG. 3, and the process 400 of FIG. 4.

At step 606, the hardware processor(s) 602 may execute machine-readable/machine-executable instructions stored in the machine-readable storage media 604 to retrieve a driving scene from a database of sensor data.

An ego vehicle may be traveling on a road. The ego vehicle may include, for example, an automobile, truck, motorcycle, bicycle, scooter, moped, recreational vehicle and other like on-or off-road vehicles. The ego vehicle may include, for example, an autonomous, semi-autonomous and manual operation. The ego vehicle may include one or more sensors that may be used to collect sensor data of information associated with the ego vehicle. The sensor data may include information including, but not limited to, an environmental condition, road condition, map, location, lane marker type, traffic, speed, direction, and object that the ego vehicle is encountering and performing. The sensor data of the ego vehicle may be used to determine the driving behavior of the ego vehicle and the driving behavior of each of one or more other vehicles. Each of the one or more other vehicles may include one or more sensors that may be used to collect sensor data of the driving behavior of itself and the driving behavior of each of the other vehicles, including the ego vehicle. Other sensors of roads, infrastructures, etc., may collect sensor data on the ego vehicle and each of the other vehicles. Many variations are possible.

The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received by at least one sensor. The ego vehicle may be monitored while traveling on the road to obtain sensor data of the ego vehicle. One or more sensors may be used to collect the sensor data of the ego vehicle. The sensor data of a plurality of vehicles, including the ego vehicle, may be collected and stored in a database. The database may be a repository of all sensor data collected by vehicles from one or more networks.

The sensor data of the ego vehicle collected from multiple sensors may be combined to provide a collective and complete driving data of the ego vehicle. Driving data of the ego vehicle may be determined from sensor data collected by one or more sensors of the ego vehicle, one or more sensors of one or more other vehicles, and one or more sensors of the road, such as, for example, road cameras, road sensors, etc. The driving data of the ego vehicle that is collected may include information of the driving behavior of the ego vehicle. The information of the driving behavior of the ego vehicle may include information on one or more driving actions performed by the ego vehicle, including, for example, the speed, movements (or lack of movements), location, direction of travel, and driving pattern of the ego vehicle. The driving data of the ego vehicle may include an identity of a driver of the ego vehicle. The information of the driving behavior may be associated with the identity of the driver.

The database of sensor data may include sensor data collected by a plurality of vehicles. The sensor data stored in the database may include a plurality of images and/or videos (“images”) collected from a plurality of vehicles by one or more sensors. The images may be of a plurality of different locations that the plurality of vehicles have traveled through. Such locations may include, but are not limited to, Paris of France, Rome of Italy, New York City of New York, Maui of Hawaii, Sydney of Australia, Tokyo of Japan, Egypt of Africa, etc. An image may be categorized in the database based on the location it was captured in. An image may also be categorized in the database based on the type of image it is presenting, such as, for example, forest, desert, city, mountains, valley, vineyard, ocean side, ranch, etc. An image may also be categorized in the database based on one or more features displayed in the image, including, for example, sunrise, sunset, daylight, moonlight, sunny, raining, snowing, thunder storm, animals, people, buildings, etc. Many variations are possible.

A driving scene may be retrieved for the ego vehicle. A passenger of the ego vehicle may select a driving scene that the passenger requests to be displayed in a cabin of the ego vehicle. The passenger may select a driving scene according to one or more options, including a location, type, and feature of the image. Based on the selected driving scene, one or more images of the driving scene may be retrieved from the database of sensor data.

At step 608, the hardware processor(s) 602 may execute machine-readable/machine-executable instructions stored in the machine-readable storage media 604 to determine a trajectory of an ego vehicle.

The driving data of the ego vehicle may be used to infer characteristics of driving behavior. The driving data of one or more other vehicles may be used to infer characteristics of the driving behavior of the ego vehicle. Characteristics of the driving behavior of the ego vehicle may include one or more types of actions performed by the ego vehicle, a degree of repetition of each type of action, a motion pattern of the driving behavior, a period of the motion pattern of the driving behavior, and a degree of influence caused by the driving behavior of the ego vehicle to other vehicles. Types of actions that may be performed by the ego vehicle may include accelerating, decelerating, braking, changing lanes, turning, and being stationary.

The driving data may be used along with other sensor data of the ego vehicle, including information on environmental conditions, road conditions, and traffic, to determine a trajectory of the ego vehicle. The trajectory of the ego vehicle may be the path of travel that the ego vehicle is traversing. The trajectory of the ego vehicle may be determined based on the present sensor data obtained during the present operation of the ego vehicle. The trajectory of the ego vehicle may be predicted, at least to an extent, according to a destination of the ego vehicle. The trajectory of the ego vehicle may be updated as the ego vehicle is in motion as the vehicle performs different types of actions. The trajectory of the ego vehicle may be updated based on changes in environmental conditions, traffic, road conditions, and other external factors that the ego vehicle encounters while the ego vehicle is traveling. Many variations are possible.

A predictive model, such as a ML model, may be used to analyze the sensor data and driving data of the ego vehicle to predict next driving actions of a vehicle. A predictive model may include a plurality of different prediction models, where each predictive model may represent a different category driving behaviors and external conditions that an ego vehicle may encounter. The predictive model may be used in determining the trajectory of the ego vehicle.

Each of the predictive models may include one or more algorithms used to determine the predicted next driving data and trajectory of the ego vehicle based on the environmental data, traffic data, and road condition data of the ego vehicle. The one or more algorithms may be pre-stored. The one or more algorithms may include a plurality of equations and methods to determine the predicted next driving data and trajectory. In other applications, each of the predictive models may include ML and/or Al logic. ML and/or Al logic may be used to determine the predicted next driving data and trajectory. The ML and/or Al logic may use data from previous sessions, whether on the same ego vehicle or other vehicles, and stored data to more quickly and efficiently determine the predicted next driving data to be performed and trajectory of the ego vehicle, including, for example, types of actions predicted to be performed and a path of travel to be taken.

At step 610, the hardware processor(s) 602 may execute machine-readable/machine-executable instructions stored in the machine-readable storage media 604 to synchronize the driving scene to the trajectory of the ego vehicle.

Upon determining the trajectory of the ego vehicle and retrieving the driving scene from the database of sensor data, the driving scene may be synchronized with the trajectory. Synchronizing the driving scene with the trajectory may include arranging images of the driving scene according to the trajectory of the ego vehicle. The driving scene may be synchronized with the current trajectory of the ego vehicle according to sensor data of the ego vehicle presently obtained during the current operation of the ego vehicle. The driving scene may be updated according to updates to the trajectory of the ego vehicle based on new sensor data obtained by the ego vehicle during its operation. The synchronized driving scene may display one or more images in alignment with the driving behavior of the ego vehicle according to sensor data collected by the ego vehicle in real-time.

At step 612, the hardware processor(s) 602 may execute machine-readable/machine-executable instructions stored in the machine-readable storage media 604 to output the synchronized driving scene to a surface of a cabin of the ego vehicle.

The synchronized driving scene may be outputted to the ego vehicle. The synchronized driving scene may be streamed to the ego vehicle and displayed on a surface of the ego vehicle. The surface of the ego vehicle may be any surface of the ego vehicle, including an internal surface of a cabin of the ego vehicle. An internal surface of a cabin of the ego vehicle may include a GUI, door panel, window, ceiling, backside of seat, etc. The synchronized driving scene may be displayed on a surface of the ego vehicle selected by the passenger of the ego. Many variations are possible.

The synchronized driving scene may be filtered before being outputted to the ego vehicle. Filtering the synchronized driving scene may include activating a mode of operation with the ego vehicle. A mode of operation may include types of driving modes, such as, for example, ACC, LTA, Off-Road, 4H, and 4L. Activating a mode of operation may limit driving actions performed by the ego vehicle. Limiting driving actions performed by the ego vehicle may allow the synchronized driving scene to be streamed more efficiently, resulting in the synchronized driving scene to be displayed more clearly and seamlessly as the trajectory of the ego vehicle updates. Activating a mode of operation with the ego vehicle may further assist with determining the trajectory of the ego vehicle more efficiently, allowing for driving scenes to be synchronized with the trajectory more proficiently.

Synchronizing driving scenes and streaming it to an ego vehicle to be displayed on an internal service of the ego vehicle may provide passengers of the ego vehicle with a new in-cabin activity to captivate and keep passengers entertained during their travels.

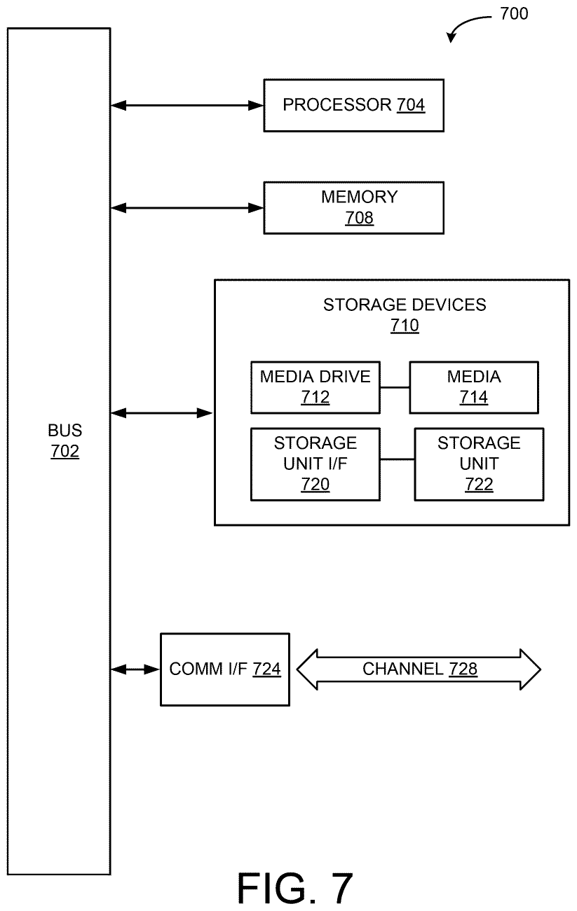

As used herein, the terms circuit, system, and component might describe a given unit of functionality that can be performed in accordance with one or more applications of the present application. As used herein, a component might be implemented utilizing any form of hardware, software, or a combination thereof. For example, one or more processors, controllers, ASICS, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software (such as user device applications described herein), these software elements can be implemented to operate with a computing or processing component capable of carrying out the functionality described with respect thereto. One such example computing component is shown in FIG. 7. Various applications are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a vehicle (e.g., vehicle, 150, vehicle 200), user device, self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability. In another example, a computing component might be found in components making up a user device, vehicle 150, vehicle 200, driving scene circuit 310, decision and control circuit 303, computing system 100, computing system 210, ECU 225, etc.

Computing component 700 might include, for example, one or more processors, controllers, control components, or other processing devices. This can include a processor, and any one or more of the components making up vehicle 150 of FIG. 1, vehicle 200 of FIG. 2, computing system 210 of FIG. 2, driving scene streaming system 300 of FIG. 3, and driving scene streaming system 400 of FIG. 4. Processor 704 might be implemented using a general-purpose or special-purpose processing engine such as, for example, a microprocessor, controller, or other control logic. The processor 704 might be specifically configured to execute one or more instructions for execution of logic of one or more circuits described herein, such as driving scene circuit 310, decision and control circuit 303, and logic for control systems 240. Processor 704 may be configured to execute one or more instructions for performing one or more methods, such as the process described in FIG. 4 and the method described in FIG. 6.

Processor 704 may be connected to a bus 702. However, any communication medium can be used to facilitate interaction with other components of computing component 700 or to communicate externally. In applications, processor 704 may fetch, decode, and execute one or more instructions to control processes and operations for enabling vehicle servicing as described herein. For example, instructions can correspond to steps for performing one or more steps of the process described in FIG. 4 and the method described in FIG. 6.

Computing component 700 might also include one or more memory components, simply referred to herein as main memory 708. For example, random access memory (RAM) or other dynamic memory, might be used for storing information and instructions to be fetched, decoded, and executed by processor 704. Such instructions may include one or more instructions for execution of one or more logical circuits described herein. Instructions can include instructions 208 of FIG. 2, and instructions 309 of FIG. 3 as described herein, for example. Main memory 708 might also be used for storing temporary variables or other intermediate information during execution of instructions to be fetched, decoded, and executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative applications, information storage mechanism 710 might include other similar instrumentalities for allowing computer programs or other instructions or data to be loaded into computing component 700. Such instrumentalities might include, for example, a fixed or removable storage unit 722 and an interface 720. Examples of such storage unit 722 and interface 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or other interface). Other examples include a communication port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 722, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

As described herein, vehicles can be flying, partially submersible, submersible, boats, roadway, off-road, passenger, truck, trolley, train, drones, motorcycle, bicycle, or other vehicles. As used herein, vehicles can be any form of powered or unpowered transport. Obstructions can include one or more potholes, cracks, tire markings, faded road markings, debris, objects, occlusion, road reflection, floodings, icy surfaces, oil leaks, uneven pavement, erosions, raveling and other potentially hazardous conditions on the road. Although roads are references herein, it is understood that the present disclosure is not limited to roads or to 1d or 2d traffic patterns.

The term “operably connected,” “coupled”, or “coupled to”, as used throughout this description, can include direct or indirect connections, including connections without direct physical contact, electrical connections, optical connections, and so on.

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, or C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof. While various applications of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various applications be implemented to perform the recited functionality in the same order, and with each of the steps shown, unless the context dictates otherwise.

Although the disclosed technology is described above in terms of various exemplary applications and implementations, it should be understood that the various features, aspects and functionality described in one or more of the individual applications are not limited in their applicability to the particular application with which they are described, but instead can be applied, alone or in various combinations, to one or more of the other applications of the disclosed technology, whether or not such applications are described and whether or not such features are presented as being a part of a described application. Thus, the breadth and scope of the technology disclosed herein should not be limited by any of the above-described exemplary applications.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various applications set forth herein are described in terms of exemplary block diagrams, flow charts and other illustrations. As will become apparent to one of ordinary skill in the art after reading this document, the illustrated applications and their various alternatives can be implemented without confinement to the illustrated examples. For example, block diagrams and their accompanying description should not be construed as mandating a particular architecture or configuration.

1. A computer implemented method implemented by one or more processors for streaming a driving scene, the computer implemented method comprising:
by at least one processor of the one or more processors, generating an output stream comprising different perspectives of a common driving scene, wherein generating the output stream comprises transitioning among the different perspectives based on one or more vehicle movement attributes;
and
by at least one processor of the one or more processors, sequentially playing back the different perspectives in the output stream on a surface of a cabin of the vehicle.

2. The computer implemented method of claim 1, wherein the one or more vehicle movement attributes are detected based on sensor data of the vehicle, the sensor data being obtained from a sensor of the vehicle, the sensor comprising camera, image sensor, radar sensor, light detection and ranging (LiDAR) sensor, position sensor, audio sensor, infrared sensor, microwave sensor, optical sensor, haptic sensor, magnetometer, communication system or global positioning system (GPS).

3. The computer implemented method of claim 2, wherein the sensor data of the vehicle comprises information of an environmental condition, road condition, map, location, lane marker type, traffic, speed, direction, and object encountered by the vehicle.

4. The computer implemented method of claim 3, wherein the object comprises pothole, crack, tire marking, faded road marking, debris, occlusion, road reflection, flooding, ice, fire, oil leak, uneven pavement, speed bump, erosion, raveling, sign, pole, building, structure, pedestrian, animal, or vehicle.

5. The computer implemented method of claim 1, wherein the common driving scene comprises a plurality of images from a database of sensor data the sensor data corresponding to a selected view.

6. The computer implemented method of claim 5, wherein the one or more vehicle movement attributes comprise a direction of travel of the vehicle, and transitioning among the different perspectives comprises aligning the different perspectives with the direction of travel of the vehicle.

7. The computer implemented method of claim 1, wherein the one or more vehicle movement attributes are based on acceleration, suspension, speed, braking maneuvering, direction, driving pattern, road condition, or environmental condition.

8. A system, comprising:
one or more processors; and
memory coupled to the one or more processors to store instructions, which when executed by at least one processor, cause the at least one processor to perform operations, the operations comprising:
generating an output stream comprising different perspectives of a common driving scene wherein generating the output stream comprises transitioning among the different perspectives based on one or more vehicle movement attributes;
and
sequentially playing back the different perspectives in the output stream on surface of a cabin of the vehicle.

9. The system of claim 8, wherein the one or more vehicle movement attributes are detected based on sensor data of the vehicle, the sensor data being obtained from a sensor of the vehicle, the sensor comprising camera, image sensor, radar sensor, light detection and ranging (LiDAR) sensor, position sensor, audio sensor, infrared sensor, microwave sensor, optical sensor, haptic sensor, magnetometer, communication system or global positioning system (GPS).

10. The system of claim 9, wherein the sensor data of the vehicle comprises information of an environmental condition, road condition, map, location, lane marker type, traffic, speed, direction, and object encountered by the vehicle.

11. The system of claim 10, wherein the object comprises a pothole, crack, tire marking, faded road marking, debris, occlusion, road reflection, flooding, ice, fire, oil leak, uneven pavement, speed bump, erosion, raveling, sign, pole, building, structure, pedestrian, animal, or vehicle.

12. The system of claim 8, wherein the common driving scene comprises a plurality of images from a database of sensor data, the sensor data corresponding to a selected view.

13. The system of claim 12, wherein the one or more vehicle movement attributes comprise a direction of travel of the vehicle, and transitioning among the different perspectives comprises aligning the different perspectives with the direction of travel of the vehicle.

14. (canceled)

15. A non-transitory machine-readable medium having instructions stored therein, which when executed by one or more processors, cause at least one processor of the one or more processors to perform operations, the operations comprising:
generating an output stream comprising different perspectives of a common driving scene, wherein generating the output stream comprises transitioning among the different perspectives based on one or more vehicle movement attributes;
and
sequentially playing back the different perspectives in the output stream on a surface of a cabin of the vehicle.

16. (canceled)

17. (canceled)

18. (canceled)

19. (canceled)

20. (canceled)

21. The computer implemented method of claim 1, further comprising:
by at least one processor of the one or more processors, causing activation of a vehicle operating mode; and
by at least one processor of the one or more processors, adjusting one or more playback parameters based on the activation of the vehicle operating mode.

22. The computer implemented method of claim 21, wherein the vehicle operating mode comprises an adaptive cruise control (ACC) mode, lane tracing assist (LTA) mode, off-road mode, four-wheel drive high range (4H) mode, or a four-wheel drive low (4L) mode.

23. The computer implemented method of claim 1, wherein the one or more vehicle movement attributes comprise an amount of movement of the vehicle during a turning maneuver, and transitioning among the different perspectives is performed in proportion to the amount of movement of the vehicle during the turning maneuver.

24. The computer implemented method of claim 1, wherein transitioning among the different perspectives comprises:
in response to a turning maneuver being executed, transitioning from a first perspective captured by a first camera of the vehicle to a second perspective captured by a second camera of the vehicle.

25. The computer implemented method of claim 1, wherein the one or more vehicle movement attributes comprise a predicted route maneuver, and transitioning among the different perspectives is performed in anticipation of the predicted route maneuver.

26. The computer implemented method of claim 1, further comprising causing one or more vehicle actuation components to perform a navigation action, wherein the one or more vehicle movement attributes correspond to the navigation action.
